(19) United States
(12) Patent Application Publication
(10) Pub. No.: US 2014/0121955 A1
(43) Pub. Date: May 1, 2014

(54) AIRCRAFT TRAFFIC MANAGEMENT COMMUNICATION SYSTEM AND METHOD

(71) Applicant: John Erickson, Louisville, KY (US)

(72) Inventor: John Erickson, Louisville, KY (US)

(21) Appl. No.: 13/956,567

(22) Filed: Aug. 1, 2013

Related U.S. Application Data
(60) Provisional application No. 61/719,656, filed on Oct. 29, 2012.

(51) Int. Cl. G08G 5/00

(52) U.S. Cl. CPC G08G 5/0013
USPC 701/120

(57) ABSTRACT

An electronic communication system for aircraft management at an airport and an aircraft traffic management method are provided. The system includes an aircraft computing system environment carried on an aircraft, an air traffic control computing system environment, a departure/arrival control computing system environment and a communications network interconnecting all of the computing system environments to establish voiceless communication therebetween.

This utility patent application claims the benefit of priority in U.S. Provisional Patent Application Ser. No. 61/719,656 filed on Oct. 29, 2012, the full disclosure of which is incorporated herein by reference.

### TECHNICAL FIELD

This document relates generally to aircraft communication and more particularly, to a new and improved electronic communication system that allows for more efficient and effective aircraft traffic management at airports.

### BACKGROUND

Pilots maneuver their aircraft on the ground from a departure gate over various taxiways to a designated runway for take-off. The pilots then must fly a designated route at a designated altitude until they reach their destination. At that time, the pilots must then land on a designated runway and follow a designated path along taxiways until reaching the arrival gate. During this process, pilots communicate with various controllers to received instructions for their movements.

Currently, all such communications are by voice communications over radio using standardized language. At busy airports each controller may be directing a number of pilots/aircraft at any one time. This can lead to cross talk and confusion.

An electronic communication system between pilots and controllers may utilize unique pilot/aircraft addresses to insure that controller instructions are only provided to the desired pilot/aircraft and not all pilots and aircraft then awaiting that controller's instructions. This eliminates cross talk and this reduces the potential for any confusion. Further, a secure communication protocol may be used for added safety. Such an electronic communication system would be more efficient and represent a significant advance in the art.

### SUMMARY

In accordance with the purposes and benefits described herein an electronic communication system is provided for aircraft traffic management at an airport. The system comprises an aircraft computing system environment carried on an aircraft, an air traffic control computing system environment, an air tower computing system environment, a departure/arrival control computing system environment and a communications network. The communications network interconnects all of the computing system environments so as to provide voiceless communication between all the computing system environments to facilitate efficient and effective movement of the aircraft through the airport. The system may further include a ramp tower computing system environment, a center computing system environment, and/or a ground crew computing system environment all also interconnected by the communications network with the aircraft, air traffic control, air tower and departure/arrival control computing system environments. The aircraft computing system environment comprises a processer, a memory, a network interface, a human interface and a display device all interconnected by a communications bus.

In accordance with an additional aspect, an aircraft traffic management method may be broadly described as comprising the steps of requesting and receiving at least one of taxiing and take-off instructions by voiceless communications between an aircraft and an airport control tower over a first computing device carried on the aircraft and requesting and receiving at least one of departure/arrival instructions over the first computing device on said aircraft.

The method may include further steps including requesting and receiving flight instructions by voiceless communication between the aircraft and center over the first computing device on the aircraft. Further the method may include requesting and receiving at least one of taxiing and push-back instructions by voiceless communication between the aircraft and ramp tower over the first computing device on the aircraft. In addition the method may include the step of requesting and receiving voiceless communication between the aircraft and ground crew over the first computing device on the aircraft.

Still further, the method may include the step of establishing a unique address for said first computing device on the aircraft so that all voiceless communication with the aircraft is aircraft specific and not shared with other computing devices on other aircraft. Further the method may include using a secure communication protocol for voiceless communication with the first computing device on the aircraft. In addition the method may include a second computing device at the airport control tower for voiceless communication with the first computing device on the aircraft over the communications network.

Still further the method may include a third computing device at the airport departure/arrival control for voiceless communication with the first computing device on the aircraft over the communications network. In addition the method may include a fourth computing device at the center for voiceless communication with the first computing device on the aircraft over the communications network. Further the method may include a fifth computing device at the ramp tower for voiceless communication with the first computing device on the aircraft over the communications network. Still further the method may include a sixth computing device for the ground crew for voiceless communication with the first computing device on the aircraft over the communications network. In addition the method includes the step of using the first computing device as a primary communications link and using voice radio communication as a secondary communications link for the aircraft. In addition the method includes entering voiceless communication to be transmitted on a human interface connected to the first computing device on the aircraft. Further the method includes displaying voiceless communication from another computing device on a display device connected to the first computing device on the aircraft.

In accordance with yet an additional aspect, an electronic communication system for aircraft traffic management at an airport is provided. The system may be broadly described as comprising an aircraft computing system environment carried on an aircraft, a second computing system environment at an aircraft control entity selected from a group of entities consisting of air traffic control, air tower, departure/arrival control, ramp tower, center and ground crew and a communications network interconnecting the aircraft computing system environment and the second computing system environment. The communications network establishes voiceless communication between the computing system environments to facilitate efficient and effective movement of the aircraft.

### BRIEF DESCRIPTION OF THE DRAWINGS

The accompanying drawings incorporated herein and forming a part of the specification, illustrate several aspects of the electronic communication system and together with the description serve to explain certain principles thereof. In the drawings:

FIG. 1 is a block diagram of an exemplary electronic communication system for implementing a method of more efficiently and effectively controlling aircraft traffic at an airport;

FIG. 2 is a block diagram of an exemplary computing device usable in the system illustrated in FIG. 1;

FIGS. 3a-3j are illustrations of exemplary user interfaces for providing information respecting position and progress of a particular aircraft.

Reference will now be made in detail to the present preferred embodiment of the electronic communication system, an example of which is illustrated in the accompanying drawings.

### DETAILED DESCRIPTION

For purposes of this document, “ramp tower” shall refer to the group that controls air traffic going in to and out of a concourse and gates at a particular airport. “Ground crew” shall refer to the group that engages and disengages the ground power, loads and unloads the luggage and moves an aircraft by means of a tow tractor. “Air traffic control” shall refer to the group that controls the runways at the airport and determines which runways should be used at which time by which aircraft. “Air tower” shall refer to the group that controls the space where the aircraft takes-off at the initial part of the flight and lands at the end of the flight. “Departure/arrival” shall refer to the group that controls the airspace after the initial take-off to a predetermined altitude (e.g. 14,000 ft.) and final decent from a predetermined altitude to touch down. “Center” shall refer to the group that controls the airspace beyond the predetermined altitude where departure/arrival no longer is responsible.

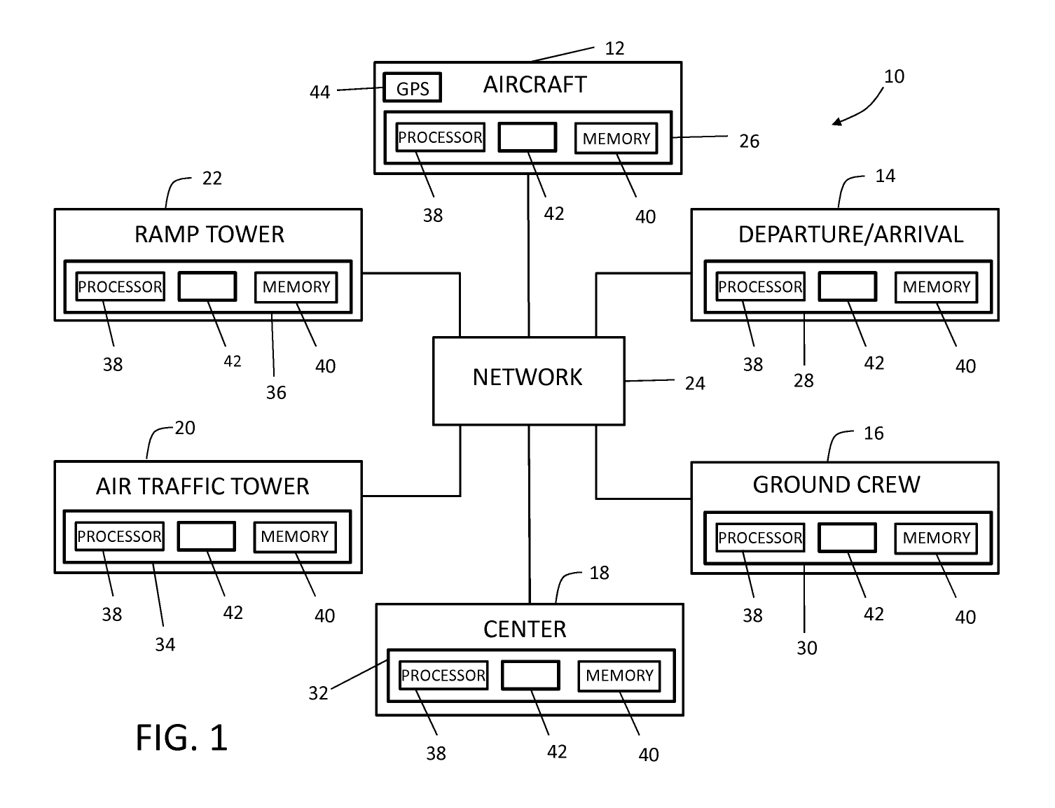

Reference is now made to FIG. 1 generally illustrating an electronic communication system 10 for air traffic management at an airport. The electronic communication system 10 includes an aircraft computing system environment 12, a departure/arrival computing system environment 14, a ground crew computing system environment 16, a center computing system environment 18, an air traffic tower computing system environment 20 and a ramp tower computing system environment 22 all interconnected by a network 24. The aircraft computing system environment 12 includes a computing device or base unit 26. The departure/arrival computing system environment 14 includes a computing device or base unit 28. The ground crew computing system environment 16 includes a computing device or base unit 30. The center computing system environment 18 includes a computing device or base unit 32. The air traffic tower computing system environment 20 includes a computing device or base unit 34. The ramp tower computing system environment 22 includes a computing device or base unit 36.

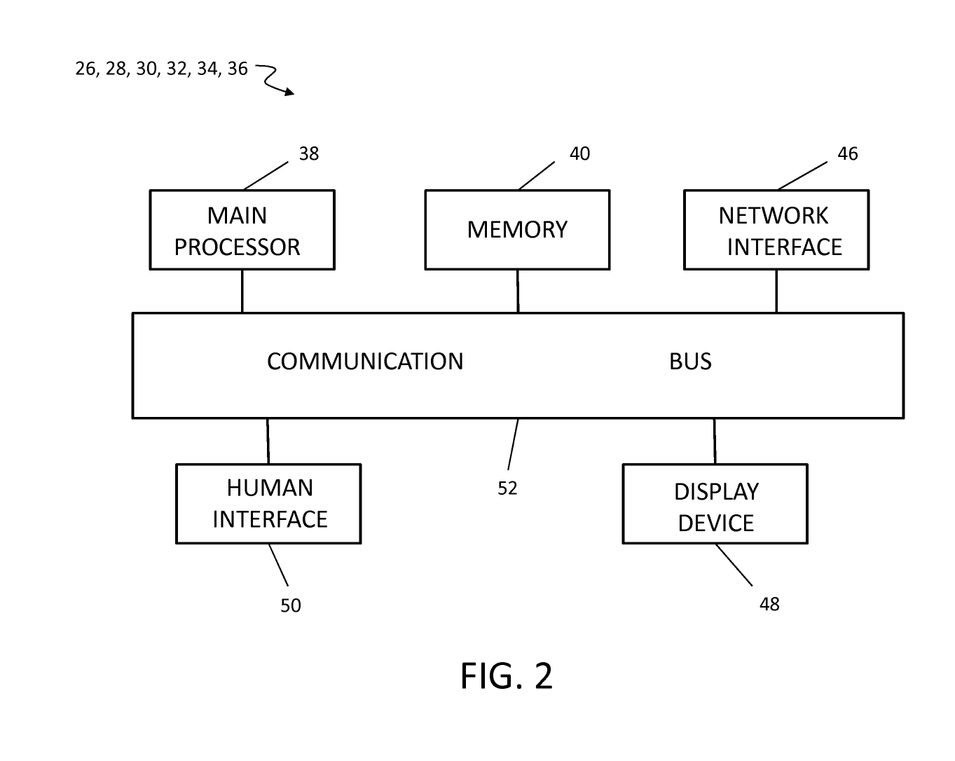

As illustrated in FIG. 2, each computing device 26, 28, 30, 32, 34, 36 may include a processor 38, a memory 40 and a communications component 42. The aircraft computing device 26 may also include a GPS/geo locator component 44. The GPS/geo locator component 44 may include a location app of a type known in the art. Alternatively, or in addition, the GPS/geo locator component 44 may include a global positioning system (GPS) receiver. Regardless of its configuration the GPS/geo locator component 44 is capable of accurately identifying the geographic position of the aircraft computing system environment 12 and thus the aircraft in which the computing system environment is located. Thus, it is possible to accurately track the position of the aircraft on the ground relative to any ground structure or landmark including, but not limited to a terminal, a gate at a terminal, a runway, a taxiway or the like. The GPS data may be transmitted from the aircraft computing system environment over the network 24 if desired to help air tower, ramp tower or other aircraft control entity follow/locate the aircraft either on the ground or in the air.

Each computing device 26, 28, 30, 32, 34, 36 is more specifically illustrated in FIG. 2. As illustrated each computing device 26, 28, 30, 32, 34, 36 includes one or more processors 38 and one or more memories 40. Further, each computing device 26, 28, 30, 32, 34, 36 further includes one or more network interfaces 46 and one or more input/output devices such as display devices 48 and human interfaces 50. As should be appreciated, all of these components 38, 40, 46, 48, 50 communicate with each other over a communications bus 52.

As should be appreciated, substantially any computing device 26, 28, 30, 32, 34, 36 having a processor can be utilized. Thus, the computing device 26, 28, 30, 32, 34, 36 may take the form of a server, a laptop, a digital assistant, a tablet computer, a personal computer or other computing device that would execute computer readable instructions. The processor 38 may be referred to as a main processor or central processing unit (CPU). The processor 38 may include a single or multiple processing cores. Where two or more cores are provided, the cores may be capable of operating in parallel.

The memory 40 may comprise any number and combination of memory devices including but not limited to cache memory, such as static random access memory (SRAM), dynamic random access memory (DRAM), enhanced DRAM or the like. Any storage repository or non-transitory machine readable storage medium of a type known in the art may also be used. The processor 38 accesses the memory 40 through the communications bus 52 to access any application or data stored thereon including, but not limited to any computer readable instructions. More specifically, the memory 40 would include a number of things including but not limited to transmitted messages, received messages, the operating system, and software applications the user would interface with to send and receive those messages. The software application would be a standalone application or it could be a collection of software presented in one “package”. A unique aircraft identification could be programmed into the memory 40 of the device 26 so that identification would be automatically transmitted as part of any communication. Airport information, including runway, taxiway and terminal and gate layout information and position maps may also be provided.

The communication system could also be made to be compatible and useable with existing systems and protocols including, for example, the Aeronautical Telecommunications Network (ATN), the Aircraft Communications Addressing and Reporting System (ACARS) and/or the Flight Management System (FMS).

The network interface 46 may be used to interface with any network 24. The network 24 may comprise any network of a type known in the art including but not limited to a local area network (LAN), a wide area network (WAN), a wireless network or any other network or network of networks including that generally known as the internet. The network 24 interconnects all of the computing system environments 12, 14, 16, 18, 20, 22 to establish voiceless communication between all of the computing system environments and thereby facilitate efficient and effective movement of the aircraft through an airport. The input/output devices may comprise one or more monitors, printers or other display devices 48 as well as human interfaces 50 including but not limited to keyboards, mice, pointers, microphones, speakers, headsets or the like.

An aircraft traffic management method may be broadly described as comprising the steps of requesting and receiving at least one of taxiing and take-off instructions by voiceless communications between an aircraft and an airport control tower over a first computing device 26 on the aircraft and requesting and receiving at least one of arrival and departure instructions by voiceless communications between the aircraft and the airport arrival and departure control over the first computing device 26 on the aircraft. In addition the method may include the step of requesting and receiving flight instructions by voiceless communication between the aircraft and center over the first computing device 26 on the aircraft. In one embodiment the method further includes the step of requesting and receiving at least one of taxiing and push-back instructions by voiceless communication between the aircraft and ramp tower over the first computing device 26 on the aircraft. In one embodiment the method further includes requesting and receiving voiceless communication between the aircraft and ground crew over the first computing device 26 of the aircraft. In one embodiment the method further includes establishing a unique address for the first computing device 26 on the aircraft so that all communication with said aircraft is aircraft specific and not shared with other computing devices on other aircraft. Further the method may include using a secure communication protocol for voiceless communication with the first computing device 26 on the aircraft. Such secure communication may be implemented by encryption protocols, authentication methodologies and/or other ways known in the art.

The method may further include a second computing device 34 at the air traffic tower for voiceless communication with the first computing device 26 on the aircraft over a communication network 24. In addition the method may include a third computing device 28 at the airport departure/arrival control for voiceless communication with the first computing device 26 on the aircraft over the communications network 24. Further the method may include a fourth computing device 32 at center for voiceless communication with the first computing device 26 in the aircraft over the communications network 24. In addition the method may include a fifth computing device 36 at the ramp tower for voiceless communication with the first computing device 26 on the aircraft over the communications network 24. Still further the method may include a sixth computing device 30 for the ground crew for voiceless communication with the first computing device on the aircraft over the communications network 24.

In accordance with one possible aspect of the method, the method may include using the first computing device 26 as a primary communications link and using voice radio communication as a secondary communication link for the aircraft. Still further the method includes entering voiceless communication to be transmitted on a human interface connected to the first computing device 26 on the aircraft. Further the method includes displaying voiceless communication from another computing device 28, 30, 32, 34, 36 on a display device 48 connected to the first computing device 26 on the aircraft.

The following describes use of the novel electronic communication system 10 and method at an airport including a ramp tower 22 and controlled ramps.

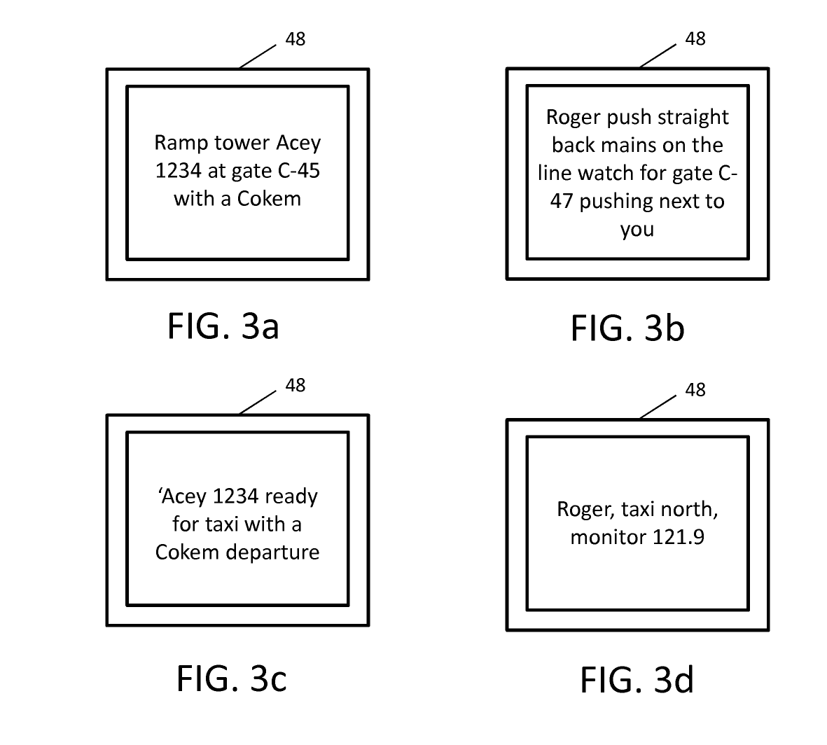

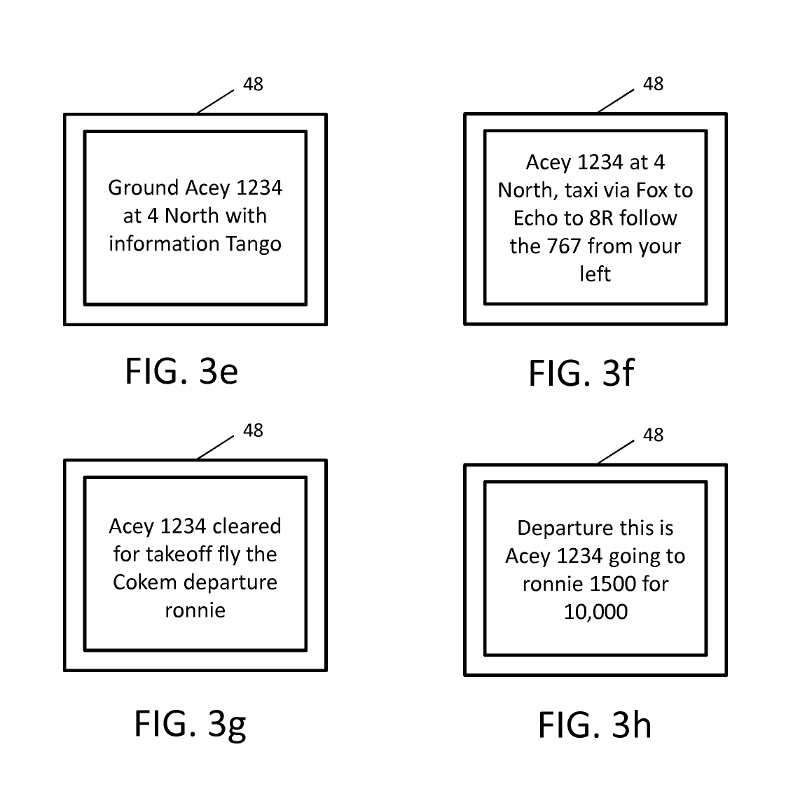

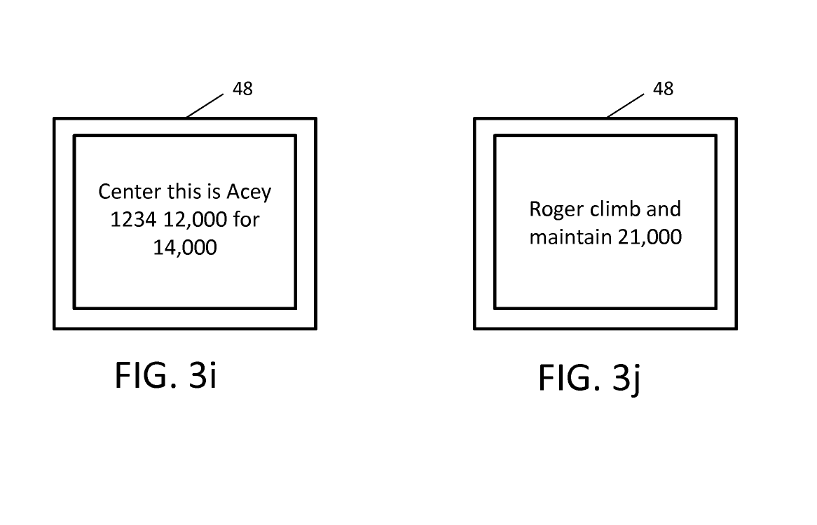

The pilot of the aircraft 12 uses the first computing device 26 in the aircraft to request push back instructions from the ramp tower 22 by voiceless communication over the communication system 10. The voiceless message from the pilot of the aircraft 12 to the ramp tower 22 would appear on a monitor 48 at ramp tower such as illustrated in FIG. 3a.

Ramp tower 22 determines the runway the aircraft will use and checks the ramp for other aircraft traffic and the relative position of any other aircraft. The pilot then receives push back and taxiing directions from the ramp tower via voiceless communication sent from the ramp tower computing device 36 over the network 24 to the aircraft computing device 26. That voiceless message could appear on a monitor or display device 48 of the aircraft computing device 26 such as illustrated in FIG. 3b.

Upon receiving the push back information from the ramp tower 22, the pilot relays the push back instructions to the ground crew 16 either by voiceless communication over the system 10 via the aircraft computing device 26, network 24 and ground control computing device 30 or via radio communication as desired. Once the aircraft 12 is pushed back into proper position and the ground crew 16 has confirmed the ground crew is clear, the pilot sets the brakes and starts the aircraft engines. The pilot then again contacts ramp tower 22 via voiceless communication from the aircraft computing device 26 over the network 24 to the ramp tower computing device 36. This time the pilot requests taxiing instructions. The request would appear on the monitor or display device 48 of the ramp tower computing device 36 such as illustrated in FIG. 3c.

Ramp tower 22 would then reply via computing device 36 over the network 24 to the aircraft computing device 26 with taxiing instructions. Such instructions would appear on the monitor 48 of the aircraft computing device 26 such as illustrated in FIG. 3d.

At this point the pilot would acknowledge the taxiing instructions received from ramp tower and taxi north to the exit of the ramp. During this time, ramp tower 22 would inform the air traffic tower 20 that the aircraft 12 was approaching the end of the ramp.

Upon reaching the end or exit point of the ramp, the pilot would request further taxiing instructions from the air traffic tower 20 via voiceless communication over the network 24 from the aircraft computing device 26 to the air traffic tower computing device 34. The voiceless message from the pilot of the aircraft 12 to the air traffic tower 20 would appear on a monitor 48 at the air traffic tower such as illustrated in FIG. 3e. The air traffic tower 20 would then provide further taxiing instructions via voiceless communication from the air traffic tower computing device 34 over the network 24 to the aircraft computing device 26. Those instructions would appear on a monitor 48 of the aircraft computing device 26 such as illustrated in FIG. 3f. The pilot of the aircraft 12 would then repeat back the taxi instructions to the tower 20 over the communication system 10 as a confirmation or acknowledgement of those instructions.

At the point when the aircraft 12 is number one to take the runway for take-off, the air traffic tower 20 sends a voiceless communication over the communication system 10 to the aircraft 12 to line up and wait. The pilot in the aircraft 12 confirms receipt of those instructions over the voiceless communication system 10. At the appropriate time the air traffic tower 20 then sends take-off instructions to the aircraft from the computing device 34 over the network 24 to the aircraft computing device 26. Those instructions would appear as illustrated in FIG. 3g on a monitor 48 of the aircraft computing device 26. The pilot would confirm receipt of the take-off instructions over the communication system 10 and then commence take-off down the runway.

Once the aircraft 12 reaches a particular designated point following take-off, the pilot contacts departure/arrival control 14 by transmitting a voiceless communication from the aircraft computing device 26 over the network 24 to the computing device 28 of departure/arrival control. An example of such a message as it would appear on the monitor 48 of the departure control computing device 28 is illustrated in FIG. 3h. Departure/arrival control 14 would acknowledge receipt of that message by voiceless communication over the communication system 10 and then provide further flight direction until turning the aircraft over to center 18. Upon reaching that point, the pilot of the aircraft 12 sends a voiceless communication from the aircraft computing device 26 over the network 24 to the center computing device 32 which would appear on the monitor 48 at center 18 such as illustrated in FIG. 3i. Center 18 would then send flight instructions to the aircraft 12 via communications system 10 which would appear on the monitor 48 of the aircraft computing device 26 such as illustrated in FIG. 3j.

Upon reaching the destination, the communication process reverses. Significantly, all communications are via secure communication protocol. The unique address for each aircraft 12 ensures that only the desired aircraft 12 receives the communication from departure/arrival control 14, center 18, air traffic tower 20 and ramp tower 22 thus avoiding possible confusion and cross talk over a communication as sometimes occurs with current radio communication of these instructions between departure/arrival control, center, air traffic tower and ramp tower with multiple aircraft. However, it should be appreciated that radio communication remains a backup to the voiceless communication system 10.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An electronic communication system for aircraft traffic management at an airport, said system comprising:
an aircraft computing system environment carried on an aircraft;
an air traffic control computing system environment;
an air tower computing system environment;
a departure/arrival control computing system environment; and
a communications network interconnecting all of said computing system environments whereby voiceless communication is established between all of said computing system environments to facilitate efficient and effective movement of said aircraft through said airport.

2. The system of claim 1 further including a ramp tower computing system environment interconnected by said communications network with said aircraft, air traffic control, air tower, departure/arrival control computing system environments.

3. The system of claim 2 further including a center computing system environment interconnected by said communications network with said aircraft, air traffic control, air tower, departure/arrival control and ramp tower computing system environments.

4. The system of claim 3 further including a ground crew computing system environment interconnected by said communications network with said aircraft, air traffic control, air tower, departure/arrival control, center and ramp tower computing system environments.

5. The system of claim 1, wherein said aircraft computing system environment comprises a processor, a memory, a network interface, a human interface and a display device all interconnected by a communications bus.

6. An aircraft traffic management method, comprising:
requesting and receiving at least one of taxiing and take-off instructions by voiceless communications between an aircraft and an airport control tower over a first computing device carried on said aircraft; and
requesting and receiving at least one of arrival and departure instructions by voiceless communications between said aircraft and airport departure/arrival control over said first computing device on said aircraft.

7. The method of claim 6, further including:
requesting and receiving flight instructions by voiceless communication between said aircraft and center over said first computing device on said aircraft.

8. The method of claim 7, further including:
requesting and receiving at least one of taxiing and push-back instructions by voiceless communication between said aircraft and ramp tower over said first computing device on said aircraft.

9. The method of claim 8, further including:
requesting and receiving voiceless communication between said aircraft and ground crew over said first computing device on said aircraft.

10. The method of claim 6, further including:
establishing a unique address for said first computing device on said aircraft so that all voiceless communication with said aircraft is aircraft specific and not shared with other computing devices on other aircraft.

11. The method of claim 10, further including using a secure communication protocol for voiceless communication with said first computing device on said aircraft.

12. The method of claim 9, further including a second computing device at said airport control tower for voiceless communication with said first computing device on said aircraft over a communications network.

13. The method of claim 12, further including a third computing device at said airport departure/arrival control for voiceless communication with said first computing device on said aircraft over said communications network.

14. The method of claim 13, further including a fourth computing device at said center for voiceless communication with said first computing device on said aircraft over said communications network.

15. The method of claim 14, further including a fifth computing device at said ramp tower for voiceless communication with said first computing device on said aircraft over said communications network.

16. The method of claim 15, further including a sixth computing device for said ground crew for voiceless communication with said first computing device on said aircraft over said communications network.

17. The method of claim 16, including using said first computing device as a primary communications link and using voice radio communication as a secondary communications link for said aircraft.

18. The method of claim 6, including entering voiceless communication to be transmitted on a human interface connected to said first computing device on said aircraft.

19. The method of claim 18, including displaying voiceless communication from another computing device on a display device connected to said first computing device on said aircraft.

20. An electronic communication system for aircraft traffic management at an airport, said system comprising:
an aircraft computing system environment carried on an aircraft;
a second computing system environment at an aircraft control entity selected from a group of entities consisting of air traffic control, air tower, departure/arrival control, ramp tower, center and ground crew; and
a communications network interconnecting said aircraft computing system environment and said second computing system environment whereby voiceless communication is established between said computing system environments to facilitate efficient and effective movement of said aircraft.
